(19) United States
(12) Patent Application Publication
(10) Pub. No.: US 2024/0227585 A1
(43) Pub. Date: Jul. 11, 2024

(54) CHARGING SYSTEM AND WIRELESS POWER SUPPLY APPARATUS FOR MOBILITY DEVICE

(71) Applicants: Hyundai Motor Company, Seoul (KR); Kia Corporation, Seoul (KR)

(72) Inventors: HoKwon Na, Seoul (KR); Yongkyu Yoo, Yongin (KR); Jaedong Shin, Hwaseong (KR)

(21) Appl. No.: 18/132,732

(22) Filed: Apr. 10, 2023

(30) Foreign Application Priority Data
Jan. 11, 2023 (KR) 10-2023-0003800

(51) Int. Cl. B60L 53/12; B60L 53/22; H02J 7/00; H02J 50/12; H02J 50/90

(52) U.S. Cl. CPC B60L 53/12; B60L 53/22; H02J 7/0044; H02J 50/12; H02J 50/90; B60L 2210/12; H02J 2207/20

(57) ABSTRACT

A charging system for a mobility device includes a charging cradle for mounting the mobility device; a wireless power supply apparatus for generating a charging power signal using power supplied from a power source and wirelessly transmitting the charging power signal; a ball joint provided in an inner space of a holder of the charging cradle and coupled to the wireless power supply apparatus so that the wireless power supply apparatus can rotate within a predetermined angular range; and a wireless charging apparatus mounted on the mobility device for wirelessly receiving the charging power signal from the wireless power supply apparatus to charge a battery of the mobility device.

### CROSS-REFERENCE TO RELATED APPLICATION

The present application claims under 35 U.S.C. § 119(a) the benefit of Korean Patent Application No. 10-2023-0003800 filed on Jan. 11, 2023, the entire contents of which are incorporated by reference herein.

### BACKGROUND

### (a) Technical Field

The present disclosure relates to a charging system and a wireless power supply apparatus for a mobility device.

### (b) Description of the Related Art

Mobility devices such as bicycles and kickboards are typically used both as exercise equipment for daily sports and recreation, and also for short-distance transportation in urban areas.

Recently, electric bicycles or electric kickboards that are charged with electricity have seen widespread use. Accordingly, a wireless charging cradle capable of wireless charging and holding a mobility device may be installed and operated.

For effective operation of a wireless charging station, it is important to provide efficient wireless charging and customer convenience.

The information included in this Background of the present disclosure is only for enhancement of understanding of the general background of the present disclosure and may not be taken as an acknowledgement or any form of suggestion that this information forms the prior art already known to a person skilled in the art.

### SUMMARY

The present disclosure is directed to providing a charging system and a wireless power supply device for a mobility device that can increase efficiency of wireless charging.

According to an exemplary embodiment of the present disclosure, a charging system for a mobility device is provided. The charging system for the mobility device includes: a charging cradle on which the mobility device is mounted; a wireless power supply apparatus for generating a charging power signal using power supplied from a power source and wirelessly transmitting the charging power signal; a ball joint provided in an inner space of a holder of the charging cradle and coupled to the wireless power supply apparatus so that the wireless power supply apparatus can rotate within a predetermined angular range; and a wireless charging apparatus for wirelessly receiving the charging power signal from the wireless power supply apparatus to charge a battery of the mobility device, wherein the wireless power supply apparatus is coupled while being positioned in the inner space formed in the charging cradle so as to be rotatable with respect to the charging cradle.

The wireless charging apparatus may be mounted on a T-bar of the mobility device.

The wireless power supply apparatus may be rotated according to an angle at which the wireless charging apparatus is mounted on the T-bar of the mobility device.

The ball joint may include a ball hinge and a shaft, the holder may include a ball joint housing positioned in an inside direction of the holder at the position of an opening formed in the inner space, and the ball hinge may be coupled to the ball joint housing so that the shaft comes out through the opening.

The charging system for mobility device may further include a spring located on a rear surface of the housing in a form surrounding the ball joint and mitigating impact when the mobility device is mounted on the charging cradle.

The wireless power supply apparatus may include a plurality of magnetic parts, and the wireless charging apparatus may include a plurality of iron parts corresponding in position to the plurality of magnetic parts, respectively.

The plurality of magnetic parts may be located in areas adjacent to each of four corners of one inner surface of the housing.

The wireless power supply apparatus may include: a housing including the plurality of magnetic parts and inserted into the inner space of the holder; a circuit board located in an inner space of the housing; and a cover covering the inner space of the housing.

The wireless charging apparatus may include: a housing including the plurality of iron parts; a circuit board located in the inner space of the housing; and a cover covering the inner space of the housing.

The circuit board may have a reception circuit patterned, the reception for receiving circuit may include: a reception controller receiving voltage information from a user; a rectifier for rectifying an AC voltage supplied from the wireless power supply apparatus into a DC voltage; and a buck converter for generating a voltage corresponding to the voltage information from the DC voltage according to the control of the reception controller.

The buck converter may include a switching element, and the reception controller may adjust a duty of the switching element based on the voltage information.

According to another exemplary embodiment of the present disclosure, a wireless power supply apparatus installed on a charging cradle where a mobility device is configured to be mounted is provided. The wireless power supply apparatus includes: a housing inserted into an inner space formed in a holder of the charging cradle; a circuit board located in an inner space of the housing and patterned with a transmission circuit configured to generate a charging power signal using power supplied from a power source and transmits the charging power signal wirelessly; a cover covering the inner space of the housing; and a ball joint provided in an inner space of the holder and that is coupled to the wireless power supply apparatus so that the wireless power supply apparatus can rotate within a predetermined angular range.

The inner space of the housing may include a plurality of magnetic parts containing a plurality of magnets, respectively, the plurality of magnets may be in close contact with a plurality of iron pieces in a plurality of iron part included in a wireless charging apparatus mounted on the mobility device by magnetic force.

The plurality of magnetic parts may be located in areas adjacent to each of four corners of one inner surface of the housing.

The wireless power supply apparatus may further include a spring located on a rear surface of the housing in a form surrounding the ball joint and mitigating impact when the mobility device is mounted on the charging cradle.

The ball joint may include a ball hinge and a shaft, the holder may include a ball joint housing positioned in an inside direction of the holder at the position of an opening formed in the inner space, and the ball hinge may be coupled to the ball joint housing so that the shaft comes out through the opening.

The wireless power supply apparatus may be rotated to match an angle at which the wireless charging apparatus is mounted on a T-bar of the mobility device.

According to one embodiment, when the mobility device is placed on the charging cradle and wirelessly charged, by minimizing adhesion failure between the wireless power supply apparatus installed on the charging cradle and the wireless charging apparatus mounted on the mobility device, magnetic force loss during power transformation between the wireless power supply apparatus and the wireless charging apparatus can be minimized and charging efficiency can be improved.

Also, according to one embodiment, charging of various types of micro mobility devices is possible through a ball joint.

### BRIEF DESCRIPTION OF THE DRAWINGS

FIG. 1 is a schematic diagram of a charging system for a mobility device according to an embodiment.

FIG. 2 is a side view showing an installation position of a wireless charging apparatus for the charging system of FIG. 1.

FIG. 3 is a front view showing the installation position of the wireless power supply apparatus shown in FIG. 2.

FIG. 4 is an exploded perspective view illustrating the disassembled wireless power supply apparatus of FIG. 2.

FIG. 5 is a perspective view illustrating a process in which the wireless power supply apparatus shown in FIG. 4 is installed in a charging cradle.

FIG. 6 is a cross-sectional view showing a ball joint housing of a mounting portion to which the ball joint shown in FIG. 5 is coupled.

FIG. 7 is an exploded perspective view illustrating the disassembled wireless charging apparatus shown in FIG. 2 in an exploded view.

FIG. 8 is a diagram showing an example of a transmission circuit of a transmission module for the charging system of FIG. 1.

FIG. 9 is a diagram illustrating an example of a reception circuit of a reception module for the charging system of FIG. 1.

### DETAILED DESCRIPTION OF THE EMBODIMENTS

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, various embodiments of the present disclosure will be described in detail with reference to the appended drawings so that a person of ordinary skill in the art may easily implement the present disclosure. As those skilled in the art would realize, the described embodiments may be modified in various different ways, all without departing from the spirit or scope of the present disclosure. The drawings and description are to be regarded as illustrative in nature and not restrictive. Like reference numerals designate like elements throughout the specification.

In the present specification, terms including an ordinal number, such as first, second, etc., may be used to describe various elements, but the elements are not limited by the terms. The above terms are used only for distinguishing one element from another element. For example, without departing from the scope of the present disclosure, a first element may be referred to as a second element, and similarly, a second element may be referred to as a first element.

Throughout the specification, when an element is referred to be “connected” with another element, it includes not only the case where two elements are “directly connected” but also the case where two elements are “electrically or mechanically connected” with another component interposed therebetween. On the other hand, when an element is referred to as “directly connected” to another element, it should be understood that no other element exists in the middle.

In the flowchart described with reference to the drawings in the present specification, the order of operations may be changed, several operations may be merged, some operations may be divided, and specific operations may not be performed.

Furthermore, in the present specification, each of the phrases such as “A or B”, “at least one of A and B”, “at least one of A or B”, “A, B, or C”, “at least one of A, B, and C”, and “at least one of A, B, or C” may include any one of the items listed together in the corresponding one of the phrases, or all possible combinations thereof.

Now, a charging system and a wireless power supply apparatus for a mobility device according to an embodiment of the present disclosure will be described in detail with reference to the drawings.

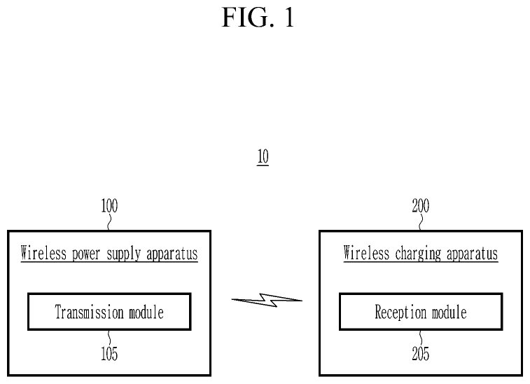

FIG. 1 is a schematic diagram of a charging system for a mobility device according to an embodiment.

Referring to FIG. 1, a charging system 10 for a mobility device includes a wireless power supply apparatus 100 and a wireless charging apparatus 200.

The wireless power supply apparatus 100 is a device that supplies power wirelessly and may include a transmission module 105. The transmission module 105 rectifies the AC voltage from commercial AC power to DC voltage, generates an AC voltage pulse using the rectified DC voltage, and applies the pulse to a transmission coil to generate a magnetic field.

The wireless charging apparatus 200 is a device for charging power wirelessly supplied from the wireless power supply apparatus 100 and may include a reception module 205. The reception module 205 flattens the AC voltage pulse induced by a reception coil magnetically coupled to the transmission coil of the transmission module 105 into DC voltage, and charge the battery of the mobility device using the DC voltage of a predetermined level.

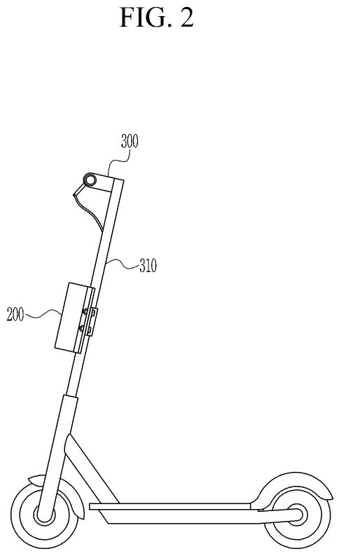

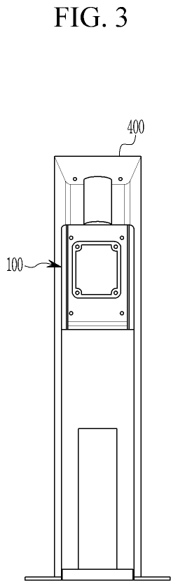

FIG. 2 is a side view showing an installation position of a wireless charging apparatus for the charging system of FIG. 1, and FIG. 3 is a front view showing the installation position of the wireless power supply apparatus shown in FIG. 2.

Referring to FIG. 2, the wireless charging apparatus 200 may be mounted on the mobility device 300.

The mobility device 300 may represent a mobile body driven by electricity. The mobility device 300 can move using the power charged in the battery, and the battery of the mobility device 300 can be charged through the wireless charging apparatus 200. The mobility device 300 may include, for example, an electric kickboard, a delivery robot car, an electric bicycle, an electric wagon, an electric stroller, and other micro mobility devices.

The wireless charging apparatus 200 may be mounted at a predetermined location of a T-bar 310 of the mobility device 300, and the mounting location of the wireless charging apparatus 200 may be changed.

Referring to FIG. 3, the wireless power supply apparatus 100 may be installed in a charging cradle 400 on which the mobility device 300 is mounted.

The wireless power supply apparatus 100 may be fixed to the charging cradle 400 through a coupling structure of a ball joint. In addition, the wireless power supply apparatus 100 can be rotated up, down, left and right up to a predetermined angle by the coupling structure of the ball joint. The predetermined angle may be, for example, an angle between 15 degrees and 30 degrees.

When the mobility device 300 is mounted on the charging cradle 400, wireless charging may be performed while the wireless charging apparatus 200 contacts the wireless power supply apparatus 100. At this time, as the angle of the wireless power supply apparatus 100 is changed by the coupling structure of the ball joint according to the inclination angle of the T-bar 310 of the mobility device 300, the two surfaces facing each other between the wireless power supply apparatus 100 and the wireless charging apparatus 200 can be properly contacted.

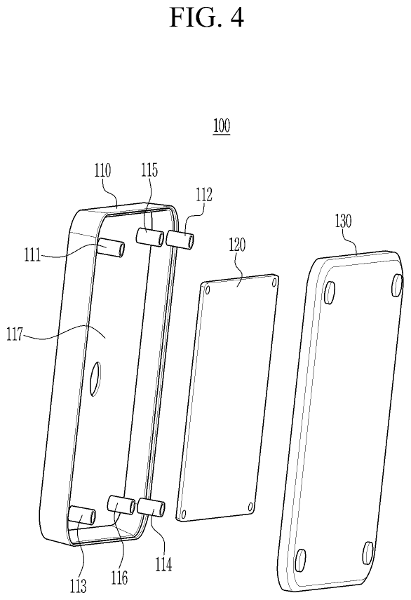

FIG. 4 is an exploded perspective view illustrating the disassembled wireless power supply apparatus shown in FIG. 2.

Referring to FIG. 4, the wireless power supply apparatus 100 may include a housing 110 having an inner space, a circuit board 120 located in the inner space of the housing 110, and a cover 130 covering the inner space of the housing 110.

The circuit board 120 may be fixed to the one inner surface 117 of the housing 110. A transmission circuit of the transmission module 105 may be patterned on the circuit board 120.

In addition, magnetic parts 111, 112, 113, and 114 may protrude from the inner surface 117 of the housing 110 in a vertical direction. The magnetic parts 111, 112, 113, and 114 may be located in a predetermined area adjacent to each of the four corners of the inner surface 117.

The magnetic parts 111, 112, 113, and 114 have magnets embedded therein.

In addition, coupling protrusions 115 and 116 protrude from the one inner surface 117 of the housing 110 in a vertical direction, and the coupling protrusions 115 and 116 are located in an area other than an area where the circuit board 120 is fixed and an area where the magnetic parts 111, 112, 113, and 114 protrude, among the one inner surface 117. The coupling protrusions 115 and 116 may be coupled to grooves (not shown in the drawing) located in the cover 130.

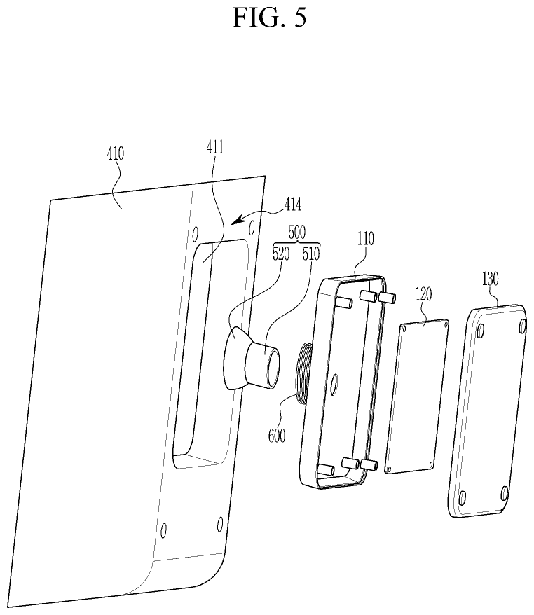

FIG. 5 is a perspective view illustrating a process in which the wireless power supply apparatus shown in FIG. 4 is installed in a charging cradle.

Referring to FIG. 5, the charging cradle 400 includes a holder 410.

The holder 410 may fix the wireless power supply apparatus 100. One side surface 414 of the holder 410 includes an area formed by being bent in an inside direction of the holder 410, and an internal space 411 may be provided by the corresponding area. The wireless power supply 100 may be inserted into the inner space 411 of the holder 410.

A ball joint 500 may be used to fix the wireless power supply apparatus 100 inserted into the inner space 411 of the holder 410.

The ball joint 500 may include a shaft 510 having a circular bar shape with a hollow inside and a ball hinge 520 having a hemispherical shape with a hollow inside.

One end of the shaft 510 is coupled to the ball hinge 520, and the other end of the shaft 510 may be coupled to the rear surface of the housing 110.

A spring 600 for impact mitigation when the mobility device 300 is mounted may be positioned on the rear surface of the housing 110. The shaft 510 may be positioned inside the spring 600. That is, the spring 600 is positioned in a form surrounding the shaft 510.

The spring 600 serves to reduce impact while being compressed when force is applied. That is, when the mobility device 300 is mounted on the charging cradle 400, the spring 600 reduce an impact applied to the wireless power supply apparatus 100 from a force pushing the mobility device 300 into the charging cradle 400. impacts the wireless power supply 100 from the force that pushes the mobility device 300 into the charging cradle 400. serves to alleviate

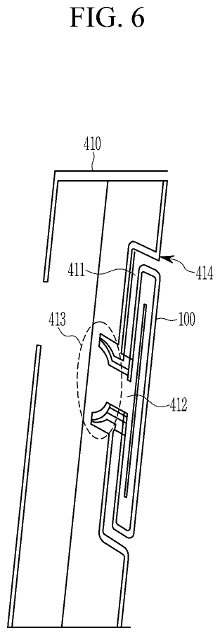

FIG. 6 is a cross-sectional view showing a ball joint housing of a mounting portion to which the ball joint shown in FIG. 5 is coupled.

Referring to FIG. 6, the central portion of the bottom of the inner space 411 of the holder 410 may have an opening 412 through which it is drilled.

The ball joint 500 may be coupled to the ball joint housing 413 so as to come out through the opening 412 from the inside of the holder 410.

The ball joint housing 413 has a shape capable of covering the outer surface of the ball hinge 520 and is formed in the direction of the inner space of the holder 410 at the position of the opening 412.

The ball joint housing 413 surrounds the outer surface of the ball hinge 520, couples the ball joint 500 to the holder 410 so that the shaft 510 comes out through the opening 412, and allows free movement of the ball joint 500.

In this way, as the free movement of the ball joint 500 is possible, the angle of the wireless power supply apparatus 100 may be changed to match the mounting angle of the wireless charging apparatus 200, and accordingly, charging efficiency may be improved by increasing the contact area between the wireless charging apparatus 200 and the wireless power supply apparatus 100.

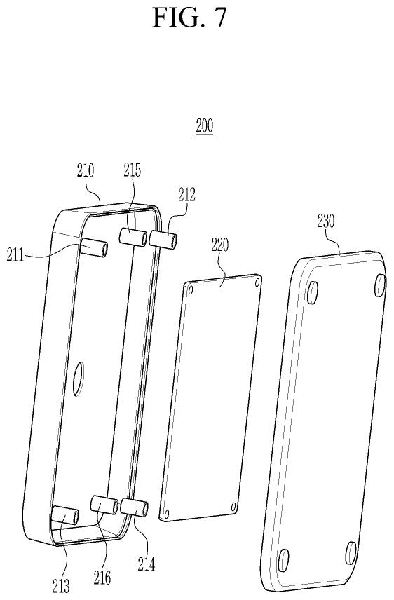

FIG. 7 is an exploded perspective view illustrating the disassembled wireless charging apparatus shown in FIG. 1 in an exploded view.

Referring to FIG. 7, the wireless charging device 200 includes a housing 210 having an inner space, a circuit board 220 located in the inner space of the housing 210, and a cover 230 covering the inner space of the housing 210.

The circuit board 220 may be fixed to the one inner surface of the housing 210. A reception circuit of the reception module 205 may be patterned on the circuit board 220.

In addition, iron parts 211, 212, 213, and 214 may protrude from one inner surface of the housing 210 in a vertical direction. The iron parts 211, 212, 213, and 214 may be located in a predetermined area adjacent to each of the four corners of the one inner surface.

The iron parts 211, 212, 213, and 214 contain iron pieces therein. Positions of the iron parts 211, 212, 213, and 214 may correspond to positions of the magnetic parts 111, 112, 113, and 114 in the wireless power supply apparatus 100. Therefore, when the wireless charging apparatus 200 and the wireless power supply apparatus 100 are in contact, the wireless charging apparatus 200 and the wireless power supply apparatus 100 can be in close contact with each other by magnetic force between the iron pieces in the wireless charging apparatus 200 and the magnets in the wireless power apparatus 100. Accordingly, during wireless charging, it is possible to prevent the occurrence of a gap due to poor adhesion between the wireless charging apparatus 200 and the wireless power supply apparatus 100, and reduce power loss caused by poor adhesion.

In addition, coupling protrusions 215 and 216 protrude in a vertical direction from one inner surface of the housing 210, and the coupling protrusions 215 and 216 are located in an area other than an area where the circuit board 220 is fixed and an area where the magnetic parts 211, 212, 213, and 214 protrude, among the one inner surface. The coupling protrusions 215 and 216 may be coupled to grooves (not shown in the drawings) located in the cover 230.

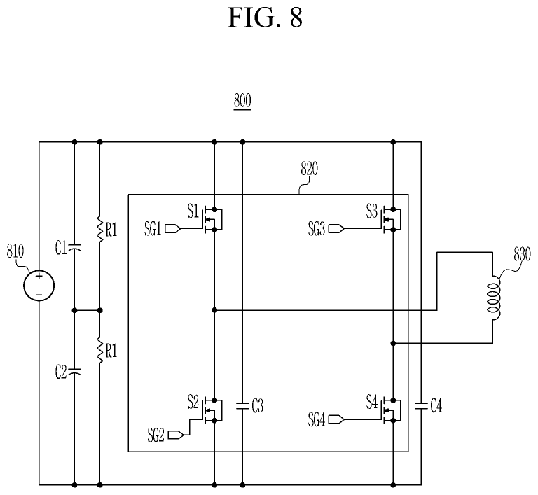

FIG. 8 is a diagram showing an example of a transmission circuit of a transmission module for the charging system of FIG. 1.

Referring to FIG. 8, the transmission circuit 800 of the transmission module 105 may include a power circuit 810, a full bridge converter 820 and a transmission coil 830.

The power circuit 810 generates a predetermined DC voltage using power input from a commercial power source (for example, 220 V).

The full bridge converter 820 generates an AC voltage pulse from the DC voltage supplied from the power supply circuit 810 and transfers it to the transmission coil 830. The full bridge converter 820 may include first to fourth switching elements Q1, Q2, Q3, and Q4. The first to fourth switching elements Q1, Q2, Q3, and Q4 may convert the DC voltage output from the power circuit 810 into an AC voltage pulse and supplies to the transmission coil 830. The first to fourth switching elements Q1, Q2, Q3, and Q4 may be turned on or off in response to first to fourth gate signals output from a control circuit (not shown in the drawing), respectively. FIG. 8 shows a full bridge converter 820 implemented with four switching elements, but is not limited thereto. For example, a half bridge converter may be used instead of the full bridge converter 820.

The first switching element Q1 and the second switching element Q2 of the full bridge converter 820 are connected in series to both ends of the power circuit 810, and a contact point between the first switching element Q1 and the second switching element Q2 may be electrically connected to one end of the transmission coil 830.

The third switching element Q3 and the fourth switching element Q4 of the full bridge converter 820 are connected in series to both ends of the power circuit 810, and a contact point between the third switching element Q3 and the fourth switching element Q4 may be electrically connected to the other end of the transmission coil 830.

Capacitors C1 and C2 may be connected in series in series between both ends of the power circuit 810, and resistors R1 and R2 may be connected in series in series between both ends of the power circuit 810. A contact point of the capacitors C1 and C2 and a contact point of the resistors R1 and R2 may be connected.

In addition, the capacitor C3 may be connected in parallel between the first switching element Q1 and the second switching element Q2 of the full bridge converter 820, and the capacitor C4 may be connected in parallel between the switching element Q3 and the fourth switching element Q4 of the full bridge converter 820.

A current sensor (not shown in the drawing) may be connected between the full bridge converter 820 and the transmission coil 830 to measure the current supplied to the transmission coil 830 from the full bridge converter 820.

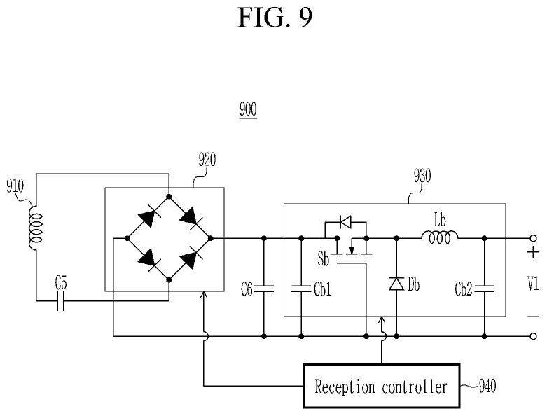

FIG. 9 is a diagram illustrating an example of a reception circuit of a reception module for the charging system of FIG. 1.

Referring to FIG. 9, the reception circuit 900 of the reception module 205 may include a reception coil 910, a rectifier 920, a buck converter 930, and a reception controller 940.

The reception coil 910 may receive an AC pulse signal induced from the transmission coil 830.

The AC pulse signal may be converted into a DC voltage signal by the rectifier 920.

The rectifier 920 is connected to both ends of the reception coil 910 and may generate a DC voltage signal by rectifying the AC pulse signal received through the reception coil 910.

The rectifier 920 may transfer the DC voltage signal to the buck converter 930. Although a full bridge rectifier implemented with four rectifier diodes is shown in FIG. 9, the rectifier 920 is not limited thereto. For example, the rectifier 920 may use a half bridge rectifier.

The DC voltage generated by the rectifier 920 may be stored in the capacitor C6.

The DC voltage generated by the rectifier 920 may be converted into a desired DC voltage V1 by the buck converter 930.

The buck converter 930 may include a switching element Sb, a diode Db, an inductor Lb, a capacitor Cb1, and a capacitor Cb2. Since the switching element Sb, the diode Db, the inductor Lb, the capacitor Cb1, and the capacitor Cb2 are circuit elements constituting the general buck converter 930, detailed explanations are omitted.

The buck converter 930 may convert the DC voltage generated by the rectifier 920 into a desired DC voltage V1. The buck converter 930 may generate a desired DC voltage V1 from the DC voltage generated by the rectifier 920 according to a control signal of the reception controller 940. That is, the buck converter 930 may generate a desired DC voltage V1 from the product of the duty of the switching element Sb and the DC voltage generated by the rectifier 920. According to one embodiment, the buck converter 930 may generate any one of 24 24 V, 36 V, and 48 V DC voltage according to the control of the reception controller 940.

The DC voltage V1 converted by the buck converter 930 may be used to charge the battery of the mobility device 300.

The reception controller 940 controls overall operations of the reception circuit 900. The reception controller 940 may adjust the level of the DC voltage V1 by controlling the duty of the switching element Sb of the buck converter 930.

The reception controller 940 may receive voltage information from a user of the mobility device 300 and control the duty of the switching element Sb of the buck converter 930 according to the received voltage information to obtain a corresponding DC voltage V1 to be output. For example, when the battery of the mobility device 300 uses a voltage of 24 V, the user may input voltage information of 24 V. The reception controller 940 may control the duty of the switching element Sb of the buck converter 930 so that a voltage of 24 V is output from the buck converter 930 according to voltage information of 24 V input from the user.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A charging system for a mobility device, the charging system comprising:
a charging cradle on which the mobility device is configured to be mounted;
a wireless power supply apparatus configured to generate a charging power signal using power supplied from a power source and wirelessly transmit the charging power signal;
a ball joint provided in an inner space of a holder of the charging cradle and coupled to the wireless power supply apparatus so that the wireless power supply apparatus can rotate within a predetermined angular range; and
a wireless charging apparatus configured to wirelessly receive the charging power signal from the wireless power supply apparatus to charge a battery of the mobility device,
wherein the wireless power supply apparatus is coupled while being positioned in the inner space formed in the holder of the charging cradle so as to be rotatable with respect to the charging cradle.

2. The charging system of claim 1, wherein the wireless charging apparatus is mounted on a T-bar of the mobility device.

3. The charging system of claim 2, wherein the wireless power supply apparatus is configured to be rotated according to an angle at which the wireless charging apparatus is mounted on the T-bar of the mobility device.

4. The charging system of claim 1, wherein:
the ball joint includes a ball hinge and a shaft,
the holder includes a ball joint housing positioned in an inside direction of the holder at the position of an opening formed in the inner space, and
the ball hinge is coupled to the ball joint housing so that the shaft comes out through the opening.

5. The charging system of claim 1, further comprising:
a spring located on a rear surface of the housing in a form surrounding the ball joint and mitigating impact when the mobility device is mounted on the charging cradle.

6. The charging system of claim 1, wherein the wireless power supply apparatus includes a plurality of magnetic parts, and the wireless charging apparatus includes a plurality of iron parts corresponding in position to the plurality of magnetic parts, respectively.

7. The charging system of claim 6, wherein the plurality of magnetic parts are located in areas adjacent to each of four corners of one inner surface of the housing.

8. The charging system of claim 6, wherein the wireless power supply apparatus includes:
a housing including the plurality of magnetic parts and inserted into the inner space of the holder;
a circuit board located in an inner space of the housing; and
a cover covering the inner space of the housing.

9. The charging system of claim 6, wherein the wireless charging apparatus includes:
a housing including the plurality of iron parts;
a circuit board located in an inner space of the housing; and
a cover covering the inner space of the housing.

10. The charging system of claim 9, wherein:
the circuit board has a reception circuit patterned, and
the reception for receiving circuit includes:
a reception controller receiving voltage information from a user;
a rectifier for rectifying an AC voltage supplied from the wireless power supply apparatus into a DC voltage; and
a buck converter for generating a voltage corresponding to the voltage information from the DC voltage according to the control of the reception controller.

11. The charging system of claim 10, wherein:
the buck converter includes a switching element, and
wherein the reception controller adjusts a duty of the switching element based on the voltage information.

12. A wireless power supply apparatus installed on a charging cradle where a mobility device is configured to be mounted, the wireless power supply apparatus comprising:
a housing inserted into an inner space formed in a holder of the charging cradle;
a circuit board located in an inner space of the housing and patterned with a transmission circuit configured to generate a charging power signal using power supplied from a power source and transmits the charging power signal wirelessly;
a cover covering the inner space of the housing; and
a ball joint provided in the inner space of the holder and coupled to the wireless power supply apparatus so that the wireless power supply apparatus can rotate within a predetermined angular range.

13. The wireless power supply apparatus of claim 12, wherein:
the inner space of the housing includes a plurality of magnetic parts containing a plurality of magnets, respectively,
the plurality of magnets are in close contact with a plurality of iron pieces in a plurality of iron part included in a wireless charging apparatus mounted on the mobility device by magnetic force.

14. The wireless power supply apparatus of claim 13, wherein the plurality of magnetic parts are located in areas adjacent to each of four corners of one inner surface of the housing.

15. The wireless power supply apparatus of claim 12, further comprising:
a spring located on a rear surface of the housing in a form surrounding the ball joint and mitigating impact when the mobility device is mounted on the charging cradle.

16. The wireless power supply apparatus of claim 12, wherein
the ball joint includes a ball hinge and a shaft,
the holder includes a ball joint housing positioned in an inside direction of the holder at the position of an opening formed in the inner space of the holder, and
the ball hinge is coupled to the ball joint housing so that the shaft comes out through the opening.

17. The wireless power supply apparatus of claim 12, wherein the wireless power supply apparatus is rotated to match an angle at which the wireless charging apparatus is mounted on a T-bar of the mobility device.
